(19) United States
(12) Patent Application Publication
(10) Pub. No.: US 2014/0247262 A1
(43) Pub. Date: Sep. 4, 2014

(54) HEAD-UP DISPLAY HAVING A PLURALITY OF PROJECTION PLANES

(71) Applicant: Johnson Controls Automotive Electronics SAS, Cergy Pontoise Cedex (FR)

(72) Inventor: Hugues Gall, Orgeval (FR)

(21) Appl. No.: 14/348,826

(22) PCT Filed: Sep. 27, 2012
(86) PCT No.: PCT/EP2012/004055

§ 371 Date: Mar. 31, 2014

(30) Foreign Application Priority Data
Oct. 1, 2011 (DE) 10 2011 114 762.8

(51) Int. Cl. G02B 27/01; G06T 15/10; G09G 5/36

(52) U.S. Cl. CPC G02B 27/0101; G09G 5/36; G06T 15/10
USPC 345/419; 345/9

(57) ABSTRACT

A head-up display in a motor vehicle has an imaging unit that generates images, and an optical device. The optical device projects the images into at least two projection surfaces, which in each case have a different distance from the eye of an observer.

The present invention relates to a head-up display in a motor vehicle.

Such head-up displays are used according to the prior art to project information which is of interest to the driver onto the windscreen of the motor vehicle. However, said displays have the disadvantage that the amount of information that can be displayed is limited.

It was therefore the object of the present invention to provide a head-up display which does not have the disadvantages of the prior art.

The object is achieved by a head-up display having at least two projection surfaces, which in each case have a different distance from the eye of the observer, for example the driver of the motor vehicle.

The present invention relates to a head-up display with which information can be displayed, for example for the driver of a vehicle, without the driver having to move his head and/or his eyes. Said information can be, for example, vehicle-relevant information, such as velocity, speed etc., or other information, such as for example infotainment information or directions from a navigation system.

According to the invention, information, for example for the driver of the motor vehicle, is then displayed on the projection surfaces. The projection surfaces are preferably arranged spatially one behind another. With particular preference, both projection surfaces are provided in the travel direction and one behind the other. One of said projection surfaces can be the windscreen of a motor vehicle. Preferably, however, at least one projection surface, with particular preference a plurality of projection surfaces, is/are a virtual projection surface in each case. The distance between a projection surface, in particular a virtual projection surface, and the eye of the observer is preferably 1.6-2.4, with particular preference 1.8-2.0 m. With particular preference information, such as the velocity of the vehicle, existing speed limits and/or information from a navigation system, is displayed on said first projection surface. With particular preference, the distance between a further, second projection surface and the eye of the observer is shorter than the distance between the first projection surface and the eye of the observer. Preferably safety relevant information, operational information of the vehicle and/or information of an infotainment system is displayed on said further, second projection surface. On both projection surfaces, numbers, letters and/or symbols can be displayed.

The items of information which are imaged on said respective projection surface can differ or be directly related to another. Preferably, the head-up display according to the invention can be used to generate 3D images.

Items of information can be displayed on the projection surfaces simultaneously and/or successively.

The projection surfaces are preferably arranged such that the observer can read information from them without moving his head. For example, a movement of the eye or of the eyes suffices to gather information from one or the other projection surface. Alternatively or additionally, information can be read from one or the other projection surface by differently focusing the eye/the eyes.

The head-up display according to the invention can have one or more imaging units. The number of the imaging units preferably equals the number of projection surfaces.

However, it is also possible to simultaneously or successively produce, using an imaging unit, a plurality of images, which are displayed simultaneously or successively in the respective projection surface. In the case of successive display, the frequency of the generated images is preferably so high that it is no longer resolvable for the human eye. Even if the images are displayed successively, the observer has the impression that they are present simultaneously.

The optical means preferably has a movable part with which the images are generated in the respective projection surface. Owing to the movement of the optical means, it is possible to switch between the projection surfaces.

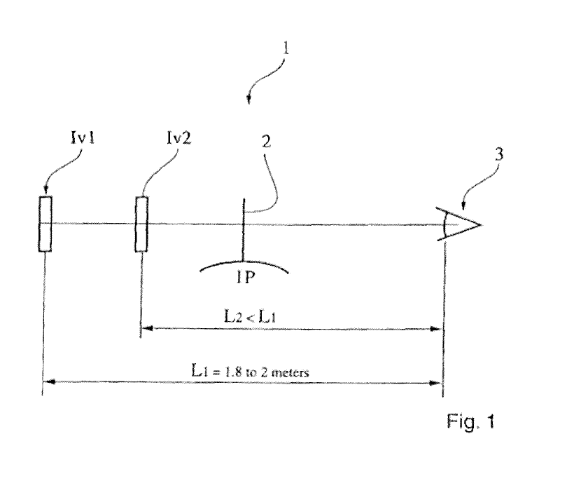

The invention will be explained below with reference to the single FIG. 1. This explanation is merely exemplary and does not limit the general idea of the invention.

FIG. 1 illustrates the head-up display 1 according to the invention. Said head-up display 1 has an imaging unit (not illustrated) which projects the images to be projected onto two projection surfaces Iv1, Iv2 using an optical means 2, in this case a mirror, which is arranged in the region of the dashboard IP of a motor vehicle. At least one, in the present case both projection surfaces are virtual projection surfaces. The two projection surfaces Iv1, Iv2 are arranged at different distances L1, L2 from the eye 3 of an observer, for example the driver of the motor vehicle. The distance of one projection surface Iv1 is preferably 1.8-2.0 m, i.e. this projection surface is located in the space in front of the windscreen of the motor vehicle. With particular preference, the other projection surface Iv2 is at a shorter distance from the eye of the observer than the projection surface Iv1. Preferably, it is likewise located in the space in front of the windscreen of the motor vehicle. Information can be displayed on both projection surfaces successively and/or simultaneously. The information, which is displayed on one projection surface Iv1, can be related to the information displayed on the other projection surface Iv2, or have completely different content. By way of example, 3D images can be generated on both projection surfaces together. Information relating to the velocity of the vehicle, existing speed limits and/or information from a navigation system is displayed with preference on the projection surface Iv1. On the projection surface Iv2, information relating to the operational state of the motor vehicle and/or infotainment information is preferably displayed.

### LIST OF REFERENCES

1 head-up display
2 optical means, mirror
3 eye of the observer
IP dashboard
Iv1 first projection surface, first virtual projection surface
Iv2 second projection surface, second virtual projection surface
L1 distance between the eye of the observer and the first projection surface Iv1
L2 distance between the eye of the observer and the first projection surface Iv2

1. A head-up display comprising:
an imaging unit which generates images, and
an optical device,
wherein the optical device projects the images into at least two projection surfaces, which in each case have a different distance from an eye of an observer.

2. The head-up display as claimed in claim 1, wherein at least one projection surface is a virtual projection surface.

3. The head-up display as claimed in claim 1, wherein the projection surfaces are arranged one behind another.

4. The head-up display as claimed in claim 3, wherein the distance between the projection surfaces is 1.6-2.4 m.

5. The head-up display as claimed in claim 1, wherein the images displayed on the projection surfaces together produce a 3D image.

6. The head-up display as claimed in claim 1, wherein the information content of the images displayed on the projection surfaces are independent of one another.

7. The head-up display as claimed in claim 1, wherein information items are displayed on the projection surfaces simultaneously or successively.

8. The head-up display as claimed in claim 1, wherein it has two imaging units.

9. The head-up display as claimed in claim 1, wherein the optical device has at least one movable part.
